(19) United States
(12) Patent Application Publication
(10) Pub. No.: US 2014/0138019 A1
(43) Pub. Date: May 22, 2014

(54) PRINTING METHOD AND PRINTING PRODUCTS EMPLOYING THE METHOD THEREOF

(71) Applicant: Chun Chit Liu, Hong Kong (HK)

(72) Inventor: Chun Chit Liu, Hong Kong (HK)

(21) Appl. No.: 14/011,770

(22) Filed: Aug. 28, 2013

(30) Foreign Application Priority Data
Nov. 16, 2012 (HK) 12111673.7

(51) Int. Cl. B32B 38/00

(52) U.S. Cl. CPC B32B 38/145
USPC 156/212; 283/85

(57) ABSTRACT

A printing method include steps: creating a 3D image corresponding to a to-be-printed image; sticking a film to a transparent sheet by removable glue; printing the 3D image on an inner surface of the film; adhering an elastic layer to the film by water based adhesive; modeling the printed film to form 3D model by vacuum plastic-absorbing machine; adding silica gel to the elastic layer to finalize the design. The printing product includes a film being printed with 3D image, an elastic layer adhered to the film by water based adhesive, silica gel added to the elastic layer for finalizing the design. As a result, the printing product is color printed with high definition, and the coating area on the 3D model is not limited. Furthermore, because the color layer is protected, the color on the 3D model is not prone to wear.

### BACKGROUND

1. Technical Field

The present disclosure relates to printing technologies, and more particular to a multicolor printing method and a printing product employing the printing method.

2. Description of Related Art

Currently, to manufacture a color three-dimensional (3D) product, such as toy, cup with 3D caving, or the like: first, to create a corresponding 3D model, then to color the 3D model by following technologies: pad transfer printing, water transfer printing, thermal transfer printing, inkjet, hand painting, or the like. As the coloring process is implemented after the 3D model has been created, the color on the 3D model is prone to wear. Furthermore, there are a lot of shortcomings by employing above mentioned technologies: as for water/thermal transfer printing, it is difficult to locate the coloring position because of manual operations; as for pad transfer printing, the coating area is limited and only single color can be colored to the 3D model in one time; as for inkjet, the speed is limited and the quality is gradually reduced while the model becomes higher.

Plastic products and soft polyvinylchloride (PVC) are manufactured by modeling and coloring at the same time. However, the thickness of the plastic product with color is limited and only thick and stiff material film can be applied to be colored, and Soft PVC has only block color with gradient.

Therefore, there is a room for improvement in the art.

### SUMMARY

Embodiments of the present invention relate to a printing method.

An embodiment of the printing method includes following steps:
S1: creating a three-dimensional (3D) image corresponding to a to-be-printed image;
S2: adhering a film to a transparent sheet by removable glue;
S3: printing the 3D image on an inner surface of the film opposite to the transparent sheet;
S4: adhering an elastic layer to the film by water based adhesive;
S5: modeling the printed film to form 3D model by vacuum plastic-absorbing machine; and
S6: adding silica gel to the elastic layer to finalize the design.

Wherein, the step S1 further comprises:
S11, determining a two-dimensional image of a product to be manufactured;
S12, creating the 3D model based on the determined two-dimensional image by cartographic software run in computer; and
S13, forming a 3D image based on the created 3D model.

Wherein, the film is EVA film.

Wherein, the thickness of the EVA film is 0.1 mm.

Wherein, the elastic layer is made form elastic fabric.

A printing product employing the above printing method is also provided. The printing product includes a film with an inner surface thereof being printed with 3D image, an elastic layer adhered to the film by water based adhesive, and silica gel added to the elastic layer for finalizing the design.

Wherein, the film is EVA film.

Wherein, the thickness of the EVA film is 0.1 mm.

Wherein, the elastic layer is made form elastic fabric.

The above printing method and printing product in the present invention have following beneficial effects: multicolor 3D printing with high definition can be achieved, the coating area on the 3D model is not limited. Furthermore, because the color layer is protected, the color on the 3D model is not prone to wear. In additional, the elasticity and hardness of the printing product can be adjusted by changing the thickness and composition of the silica gel, thus, the printing product has high elasticity.

The following detailed description, together with the accompanying drawings will provide a better understanding of the nature and advantages of the present invention.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts through out the several views.

FIG. 1 is a flow chart of a printing method in accordance with an embodiment.

FIG. 2A is a view showing a two-dimensional image employed by the printing method of FIG. 1.

FIG. 2B is a view showing a 3D image corresponding to the two-dimensional image of FIG. 2A.

FIG. 2C is a view showing a 3D model synthesized by the two-dimensional image of FIG. 2 and the 3D image of FIG. 3.

FIG. 3 is a explored view of a printing product in accordance with an. embodiment.

FIG. 4 is a cross section view of the printing product in accordance with an embodiment.

### DETAILED DESCRIPTION

The disclosure is illustrated by way of example and not by way of limitation in the figures of the accompanying drawings in which like reference indicate similar elements. It should be noted that reference to “an” or “one” embodiment in the disclosure are not necessarily to the same embodiment, and such references mean “at least one”.

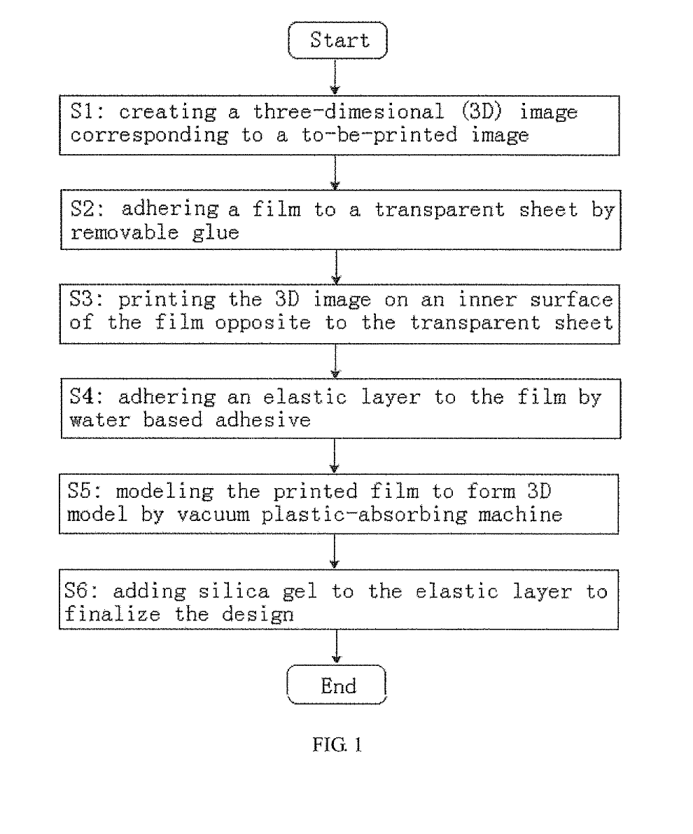

FIG. 1 illustrates a printing method for manufacturing a color 3D product. The method includes following steps:

In step S1, by virtue of cartographic software run in computer, to create a 3D model image corresponding to a to-be-printed image for preparing for printing.

Step S1 further includes following steps:

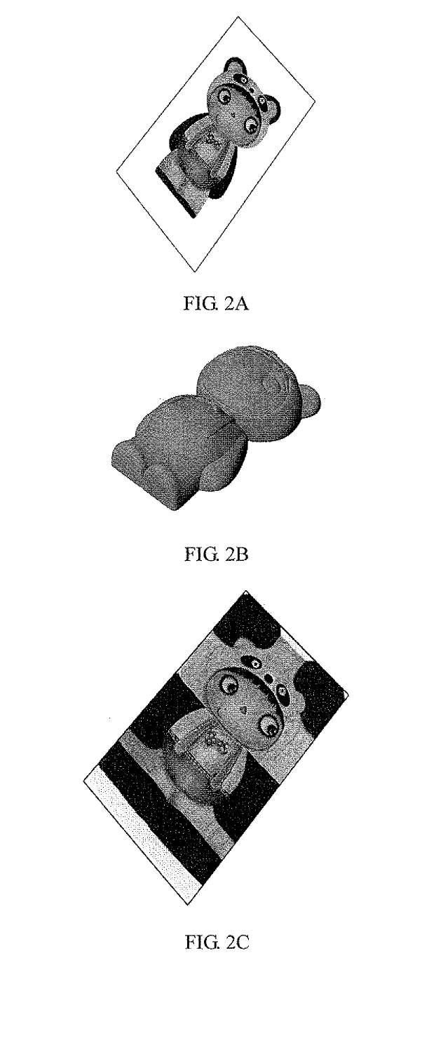

Step S11, to determine a two-dimensional image (see FIG. 2A) of a product to be manufactured.

Step S12, to create the 3D model (see FIG. 2B) based on the determined two-dimensional image by cartographic software run in computer.

Step S13, to form a 3D image (see FIG. 2C) based on the created 3D model.

In step S13, computer software is applied to stretch the simulated 3D model into stereoscopic model. For example, as for a 3D model, 3D Studio Max software is required for correct mapping operations to different parts of the 3D model with different texture coordinates, then the 3D model is stretched into a plane according to blocks, and then mapping software (such as PHOTOSHOP or the like) is applied to paint/texture in the extended plane.

In step S2, a film is adhered to the transparent sheet by removable glue. The film may be heat shrink film. In the embodiment, the film is ethylene vinyl acetate (EVA) film, with the thickness from approximately 0.1 mm to approximately 0.5 mm. The optimum thickness of the EVA film is 0.1 mm. The film can also be Polyurethane (PU), or Soft PVC, each with thickness from approximately 0.1 mm to approximately 0.5 mm. The mentioned transparent sheet is used to stiff the film, to allow the film being capable of printed by printing machine.

In step S3, the 3D image is printed on an inner surface of the film opposite to the transparent sheet in offset printing method, silk-screen printing, Inkjet, or the like. Because the printed 3D image may be colorized, the step S3 further includes a process of coloring the film.

In step S4, an elastic layer is adhered to the film by water based adhesive. The elastic layer in the embodiment is made from elastic fabric.

In step S5, the printed film is modeled to form 3D model by vacuum plastic-absorbing machine.

In step S6, adding silica gel to the elastic layer to finalize the design. The thickness of the silica gel is form approximately 1 mm to approximately 1 cm. The appropriate thickness is determined according to a desired elasticity of the elastic layer. Furthermore, the hardness of the silica gel is adjustable according to the material thereof.

After steps S1˜S6 are finished in order, the transparent sheet is removed to manufacture the desired color 3D product. As a result, various products can be manufactured according to the above printing method.

The said offset printing is a commonly used printing technique. In offset printing, the inked image is transferred or offset from a printing plate to a rubber blanket, then to the printing surface.

By virtue of the above printing method, the printing speed is high, multicolor 3D printing with high-definition can be achieved, and the coating area on the 3D model is not limited. Furthermore, because the color layer is protected, the color on the 3D model is not prone to wear.

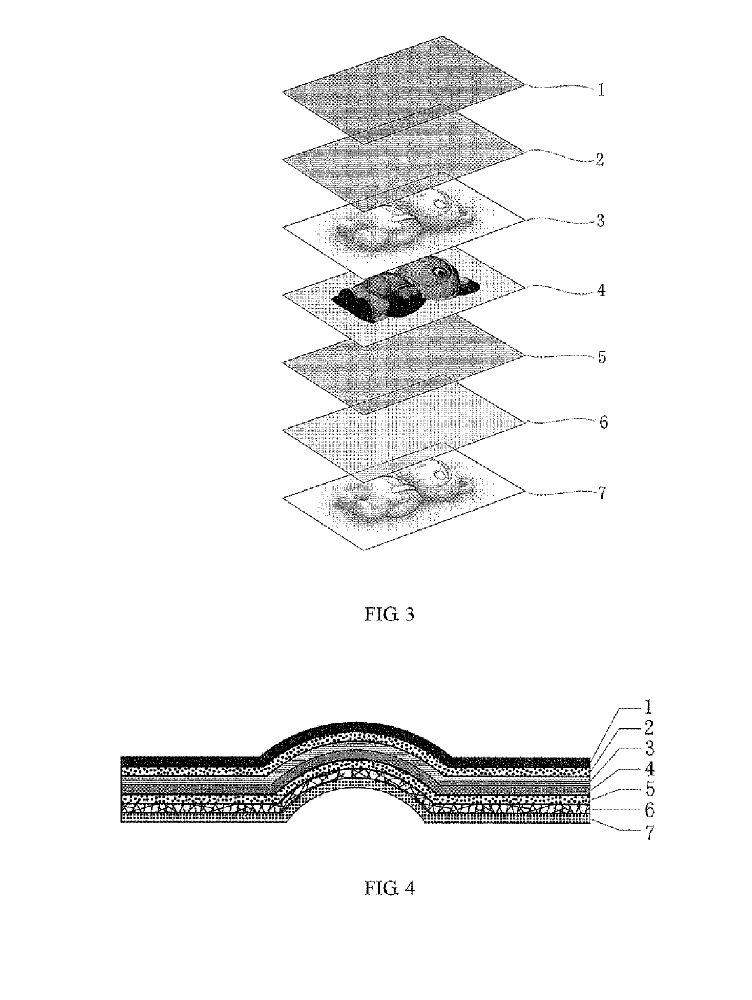

Referring to FIGS. 3-4 show a printing product manufactured by applying above printing method. The printing product includes a film 3 with an inner surface thereof being printed with 3D image, an elastic layer 6 adhered to the film 3 by water based adhesive, and silica gel 7 added to the elastic layer 6 for finalizing the design. For ease of printing, a transparent sheet 1 is adhered to an outer surface of the film 3 opposite to the said inner surface by removable glue 2. The transparent sheet 1 is removed after the printing process is finished. It is understood that, in another embodiment, the transparent sheet 1 is not removed and as a part of the printing product.

The film 3 may be heat shrink film. In the embodiment, the film 3 is EVA film with the thickness being 0.1 mm. The elastic layer 6 is made from elastic fabric.

The printing product with paint coating on the inner surface of the film 3 to form the painting layer 4, thus the printing product is protected form wearing and being faded. The elasticity and hardness of the printing product can be adjusted by changing the thickness and composition of the silica gel 7. As a result, soft products such as dolls, hollow products such as knapsacks, decorations for saving pots, or the like can be manufactured.

Although information as to, and advantages of, the present embodiments have been set forth in the foregoing description, together with details of the structures and functions of the present embodiments, the disclosure is illustrative only; and changes may be made in detail, especially in the matters of Shape, size, and arrangement of parts within the principles of the present embodiments to the full extent indicated by the broad general meaning of the terms in which the appended claims are expressed.

What is claimed is:

1. A printing method, comprising:
S1: creating a three-dimensional (3D) image corresponding to a to-be-printed image;
S2: sticking a film to a transparent sheet by removable glue;
S3: printing the 3D image on an inner surface of the film opposite to the transparent sheet;
S4: adhering an elastic layer to the film by water based adhesive;
S5: modeling the printed film to form 3D model by vacuum plastic-absorbing machine; and
S6: adding silica gel to the elastic layer to finalize the design.

2. The printing method of claim 1, wherein step S I further comprising:
S11, determining a two-dimensional image of a product to be manufactured;
S12, creating the 3D model based on the determined two-dimensional image by cartographic software run in computer; and
S13, forming a 3D image based on the created 3D model.

3. The printing method of claim 1, wherein the film is EVA film.

4. The printing method of claim 3, wherein the thickness of the EVA film is 0.1 mm.

5. The printing method of claim 1, wherein the elastic layer is made form elastic fabric.

6. A printing product employing the printing method claimed in claim 1, comprising:
a film with an inner surface thereof being printed with 3D image;
an elastic layer adhered to the film by water based adhesive; and
silica gel added to the elastic layer for finalizing the design.

7. The printing product of claim 6, wherein the film is EVA film.

8. The printing product of claim 7, wherein the thickness of the EVA film is 0.1 mm.

9. The printing product of claim 6, wherein the elastic layer is made form elastic fabric.
